(19) United States
(12) Patent Application Publication
(10) Pub. No.: US 2008/0215560 A1
(43) Pub. Date: Sep. 4, 2008

(54) INFORMATION TECHNOLOGY MANAGEMENT SYSTEM DATABASE FOR COORDINATING THE INFORAMTION TECHNOLOGY ACTIVITES FOR A BUSINESS ENTERPRISE

(76) Inventors: Denise Ann Bell, Austin, TX (US); Deborah H. Bandera, Austin, TX (US); Richard Walton Ragan, Round Rock, TX (US); Billy Brooks York, Pflugerville, TX (US); Alex Dudley Little, Raleigh, NC (US)

Correspondence Address: IBM CORPORATION;INTELLECTUAL PROPERTY LAW, 11400 BURNET ROAD, AUSTIN, TX, 78758, US

(21) Appl. No.: 11/680,649

(22) Filed: Mar. 1, 2007

(51) Int. Cl. G06F 17/30; G06F 7/00

(52) U.S. Cl. 707/5; 707/E17.005

(57) ABSTRACT

A business enterprise level information technology management system database implementation providing search results responsive to a user query that filters the extensive data that may be generated in the search result so that the user and his need for data is taken into account. An implementation determining the role of the requesting user relative to the selected activities, tracking the frequency of use of the requesting user's actions relative to the selected activities and presenting the search results to the requesting user with suggested user actions customized based upon said role of the user and prioritized based upon said frequency of use.

### TECHNICAL FIELD

The present invention relates to an information technology database, and particularly to the presentation of search results from a user requested search.

### BACKGROUND OF RELATED ART

As a result of the rapid expansion of the Internet over the past decade, extraordinary worldwide communication channels and resources have become available to businesses. This has commenced an era that forever changed how business processes and operations are conducted. The era is marked by what may be referred to as operational enterprises, i.e. businesses relying on information technology management system databases to provide data on all aspects of business operations.

ITIL (Information Technology Infrastructure Library) has become the industry standard defining the best practice approaches to deliver high quality information technology services. ITIL defines an extensive set of management procedures intended to support businesses in achieving effective IT operations.

A particularly valuable function of ITIL has been the Service Support function that is concerned with how the “User” of the services has access to appropriate services to support the needed business functions. In a business enterprise, the entry point into the technology management database is through queries requesting changes or updates. Because business enterprise infrastructures are continually reaching higher and higher levels of complexity, even routine search queries to the information technology management system database may result in search results that present considerably more information than the user can effectively handle. This is particularly the case with workers with limited information technology skills who may thereby be confused by the information presentation display or like environment.

### SUMMARY OF THE PRESENT INVENTION

The present invention provides a business enterprise level information technology management system database implementation generating search results responsive to a user query that filters the extensive data in the search result so that the user and his need for data is taken into account. This eliminates data not needed by the user and organizes the remaining data based upon predetermined and known user needs.

Accordingly, the present invention, in response to a user search request, conducts the general search of the management system database to generate the user requested information with respect to business enterprise activities of interest to the user as the search result. In such a search environment, the present invention provides an implementation comprising determining the role of the requesting user relative to the activities selected for search, tracking the frequency of use of the requesting user's actions relative to the selected activities and presenting the search results to the requesting user; with suggested user actions customized based upon said role of the user and prioritized based upon said frequency of use. The results may most effectively be presented on a display. The information technology management database, preferably, conforms to ITIL standards. The invention may most effectively be used with change and configuration management databases; to be hereinafter described in greater detail.

In accordance with a further aspect of this invention, there is a determination of the operating mode of the requesting user relative to the selected activities and further customizing the suggested user actions based upon the operating mode of the requesting user.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a very generalized view of a network, e.g. web, portions showing how individual participating users at network display stations may be interconnected with the information technology management for the implementation of searches;

FIG. 2 is a block diagram of a data processing system including a central processing unit and network connections via a communications adapter that is capable of functioning as users' computer controlled display stations on which the display system of the present invention may interactively query and be accessed, as well as functioning as the variety of network servers used in the network;

FIG. 3 is a diagrammatic view of a display screen on a computer station showing a representation of results of a user query to information technology management system database including a prioritized list of actions based upon the user role;

FIG. 4 is a view of another display screen showing more specific representations of search results of a user query like that of FIG. 3;

FIG. 5 is a listing of several service support and delivery roles that designated users may have in relation to the activities that may be selected in user queries;

FIG. 6 is an example including a representative list of possible operating modes of the user requesting the search;

FIG. 7 is an illustrative flowchart describing the setting up of the process of the present invention for providing search results responsive to a user query that filters the extensive data that may be generated in the search result so that the user and his needs for data are taken into account; and

FIG. 8 is a flowchart of an illustrative run of the process setup in FIG. 7.

### DETAILED DESCRIPTION OF THE PREFERRED EMBODIMENT

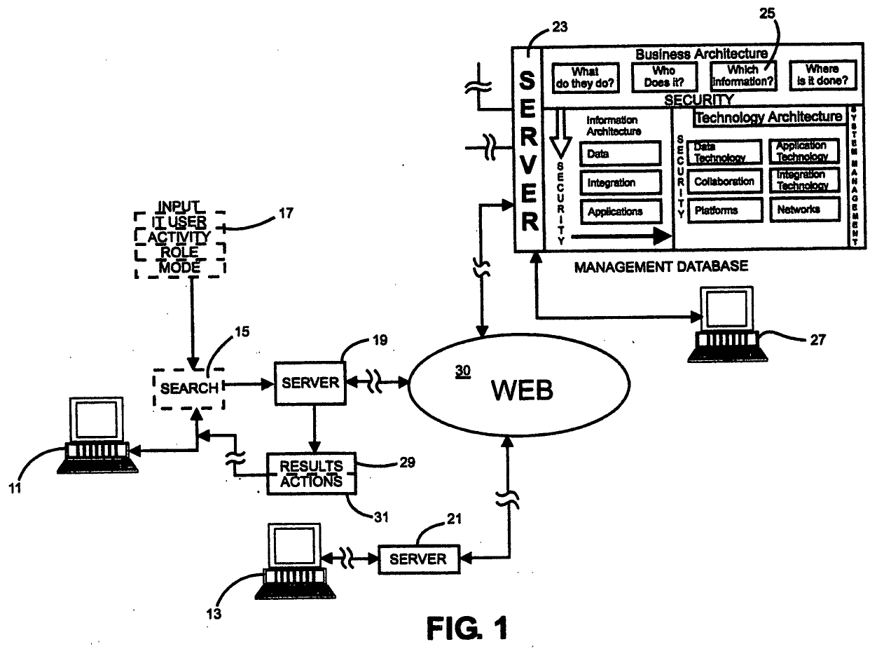

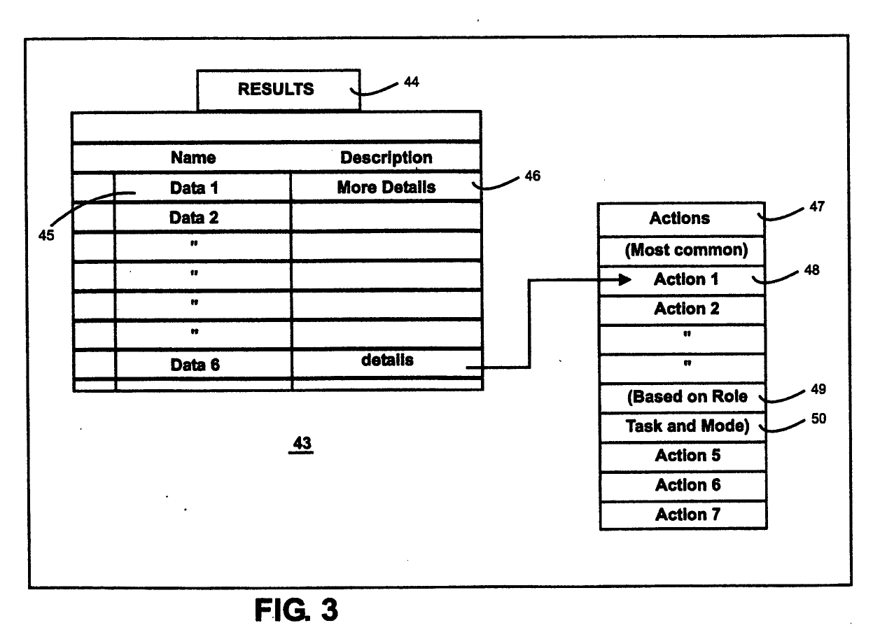

With reference to FIG. 1, there is illustrated a very generalized view of a network supporting an information technology management system database for the coordination of information technology activities for a business enterprise. In the example shown, the individual units of the enterprise are interconnected via the Internet or Web 30 (the terms are used interchangeably). The portion shown illustrates how individual participating users at network display stations 11 or 13 may be interconnected with the information technology management system database 25, hereafter referred to as the management database. This database is formed under and compliant with the ITIL standard. It includes three major conventional sections: information Architecture storing all control data, as well as applications and integration data; Technology Architecture including data technology, application technology, platforms, networks and integration and collaboration thereof; and the Business Architecture including all data on the business enterprise including What is done, Who does it, Where and Which IT information is needed and input. The management database 25 is interconnected to the network 30 and controlled by appropriate servers, as represented by server 23 accessed by management terminal 27. The individual user terminals 11 and 13 are respectably connected to management database 25 via network 30 through their respective servers 19 and 21. In an example of a search of database 25 responsive to a query from user terminal 11, as outlined, search query 15 customarily includes input data 17 identifying the user, his role in the business enterprise, the operating mode of the user for which he is currently requesting the information and the selected business enterprise activities to which the search is directed. The input search request data may be entered directly by the user or it may be stored as part of a user profile, either in association with terminal 11 or at the server 19 for the terminal. The results 19 of the search in management database 25 are transmitted to the user at terminal 11. These results will include user actions 31 that the user may selectively perform. The searching and the handling of search results by the user will be hereinafter described in greater detail with respect to FIGS. 3 through 8.

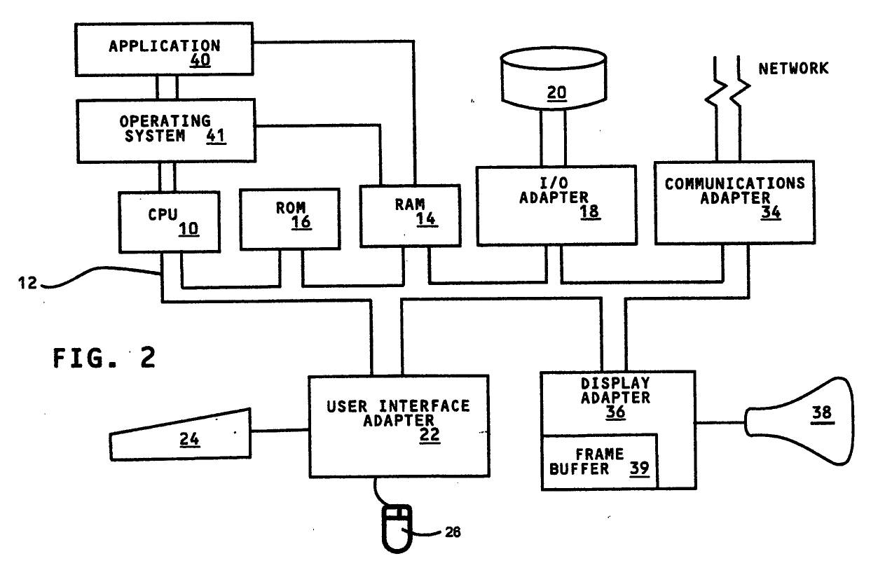

Reference is now made to FIG. 2 that represents a typical data processing display terminal that may function as the computer controlled display stations or terminals through which the participating users may send queries to the business enterprise management database, and receive the search results, hereinafter described in detail, from the management database. A central processing unit (CPU) 10, such as one of the PC microprocessors or workstations, e.g. System Pseries available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsXP™, as well as various other UNIX and Linux operating systems. Application programs 40, controlled by the system, are moved into and out of the main memory Random Access Memory (RAM) 14. These programs include the programs of the present invention for searching the management database to be described hereinafter in greater detail with respect to FIGS. 3 through 8. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over networks including the Web. I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

FIG. 3 is a diagrammatic view of a display screen on a user computer terminal showing a general representation of results of a user query to an information technology management system database with respect to user selected activities in the overall business enterprise operation. The results shown are responsive to a user query that identified the user, listed the organization activities, i.e. functions of interest, defined the user's role in the organization and optionally defined the operating mode of the requesting user. The results 44, FIG. 3, are displayed in tabular form and include a list 45 of potential functions of interest with descriptions of each 46 and a list 47 of suggested actions or tasks that could selectively perform relative to one or more of these functions. These actions 48 are prioritized (actions 1 through 7) based upon the history of the user in using such functions. As an example, since users are likely to have continuing roles in the business enterprise, actions and tasks are likely to be repetitively performed by the users. Any conventional program for monitoring user performance of actions and keeping track of the frequency of user actions may be used for this purpose. These actions are customized to suit the user's role in the business enterprise 49 and may optionally also be customized to suit a particular mode of operation on the part of the user. Some typical modes of operation as listed 60 in FIG. 6 are Monitoring, Trouble shooting, Measuring, Monitoring, Reporting, Locating and Researching. For convenience in illustration in FIG. 3, the Results and Actions were shown in general terms. However, in order to clarify the use of the Results and Actions in FIG. 31 the following example is offered.

This example has been selected from standardized CCMDB (Configuration and Change Management Database) environment. The invention is particularly advantageous when used with the standard ITIL Change and Configuration Management Database (CCMDBs) systems. These CCMDB systems have the function of implementing change within a business enterprise environment. With such a system, any authorized user may preview all pending changes in order to anticipate the business impact on his activities including disruptions when proposed changes, e.g. product upgrades, are implemented. With enterprise wide business infrastructures at high complexity levels, common information technology changes, e.g. patches, requires updating of patch levels on many different servers. The following example is intended to illustrate how the present invention may contribute in reducing patching in an ITIL CCMDB environment.

Tom (user) is an administrator (role) in a large business company (for which enterprise the IT management database is maintained). Tom is responsible for creating software packages (role) to be distributed. He is interested in security patches (activity) for which he queries a software data catalog maintained in the management database. The results show a table with five potential published patches (functions). The user may select to view any of the listed functions. With the selection of a function, the user is presented with a list of actions that he may selectively take. The list is based upon his role in the business and his history of previously using such actions. These actions would be prioritized based upon the historical frequency of use. Thus, in this example, the list includes:
Create Software Package
Delete or mark these patches as deferred
Run a query to determine what systems need these patches.

In a different example, Fred is an IT manager (role) of twenty employees in a business organization who manages 10,000 systems for the organization. An extraordinary number of system failures have come to his attention. To explore the problem, Fred (in a trouble shooting mode) runs a search on the management database to find all system failures (activity) in the past 24 hours. His results indicate a very large number of failures (36 failures as compared to the normal 1 or 2 failures). Each failure listing includes the identity of the user reporting the failure and the appropriate error description. For each listed failure, the user is offered suggested actions based upon the combination of the user, Fred's role, his history or record of selected actions and even his trouble shooting mode of operation. For example, with respect to a selected failure, Fred may get the following prioritized list of actions:
Send notice to all problem owners for status
Run query to determine impact of failures
Initiate a reschedule on selected failures
Initiate a reschedule on all failures
   Fred may then select one or more of the suggested actions appropriate to his needs. In an ancillary aspect of the present invention, the user, Fred may maintain a database in association with his own terminal or its server including actions that Fred may have to take in response to one of the actions suggested in the results from the management database. It is important to note that these ancillary potential actions are not stored in the management database because these actions are specific to Fred's circumstances. For example, if Fred selects the action:
“Initiate a reschedule on all failures”, based upon his past history of such an emergency situation, the selection triggers his local database system to make a list of ancillary actions:
e-mail all twenty employees to commit to a a total of X hours
call maintenance for a Saturday opening
check vacation schedules
etc., etc. . . .

These ancillary actions may also be prioritized, as described above, based upon the history of the user in using such functions. As an example, since users are likely to have continuing roles in the business enterprise, even ancillary actions and tasks are likely to be repetitively performed by the users. Any conventional program for monitoring user performance of actions and keeping track of the frequency of performance of user actions may be used for this purpose.

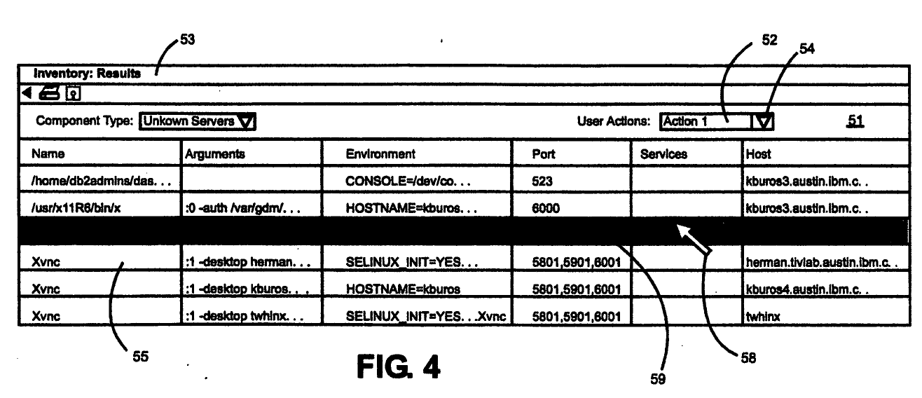

The computer display screen of FIG. 4, like the screen described above with respect to FIG. 3, is a screen presenting query or search results. However, instead of generic items for results and actions, the screen 51 of FIG. 4 displays tangible results 53 from a typical query consisting of a list 55 functions of interest. The user may then select a function of interest 59 by cursor 58. The user may then use scroll button 54 to scroll through actions 52 available to the user with respect to function 59. Like the actions 47 in FIG. 3, these actions 52 in FIG. 4 are prioritized based upon the history of the user in using such functions.

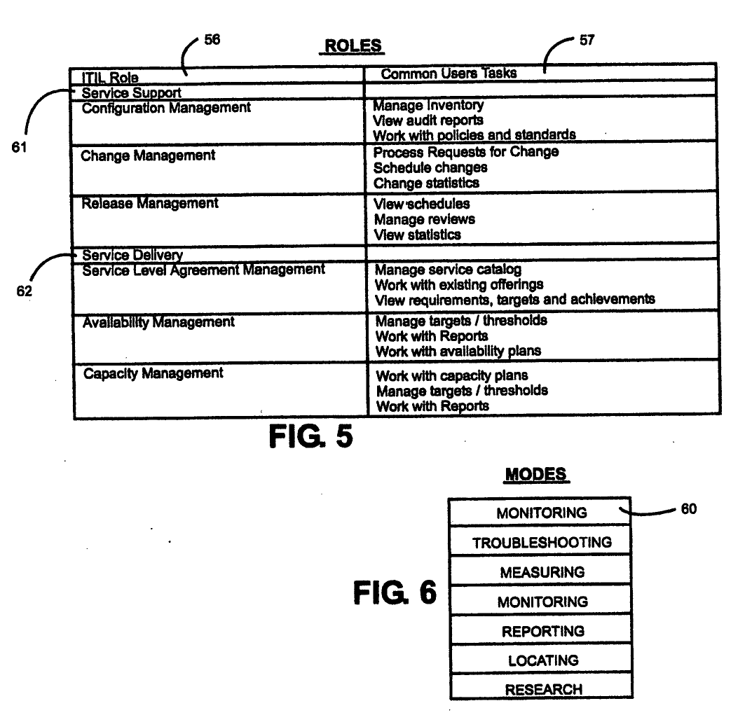

These actions 52 are likewise customized to suit the user's role in the business enterprise. In this regard, reference is made to FIG. 5 that shows a listing of some typical roles 56 that a user and participant may be performing in a business enterprise managed through an ITIL standard information technology system database, and including roles in furtherance of Service Support 61 and Service Delivery 62.

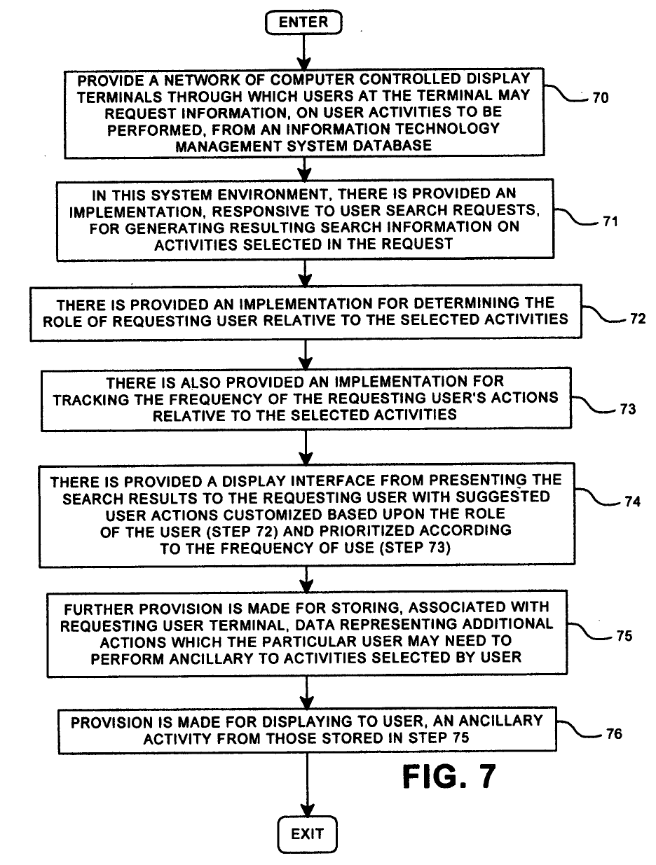

Now, with reference to FIG. 7, we will describe the setting up or development of a program according to the present invention for searching the information technology management database for the coordination of user activities to generate and display a list of user actions customized based upon the role of the user in the enterprise and upon the frequency of use of the users' past actions with respect to a specific function or activity listed in the results. There is provided a conventional network, e.g. Web, of computer controlled terminals through which users may request information on particular enterprise activities or functions from the database, step 70. There is provided an implementation, responsive to a user request for a search, for generating resulting search information with respect to the activities designated in the search request, step 71. Provision is also made for determining the role of the requesting user relative to the activities or functions selected for search, step 72. With respect to the activities or functions selected in step 72, there is provided an implementation for tracking the frequency of the user's past actions relative to the activities or functions, step 73.

Provision is made, step 74, for the presentation of the search results to the user on a display so that the requesting user's suggested actions are customized based upon the user's role, determined in step 72, and the frequency of past use of such actions in step 73. Storage is provided, in association with the terminal of the requesting user of data representative of additional actions that the specific user may wish to perform ancillary to the particular activities or functions for which the search results are presented, step 75. Provision is also made, step 76, for the display to the user of the ancillary activities stored in step 75.

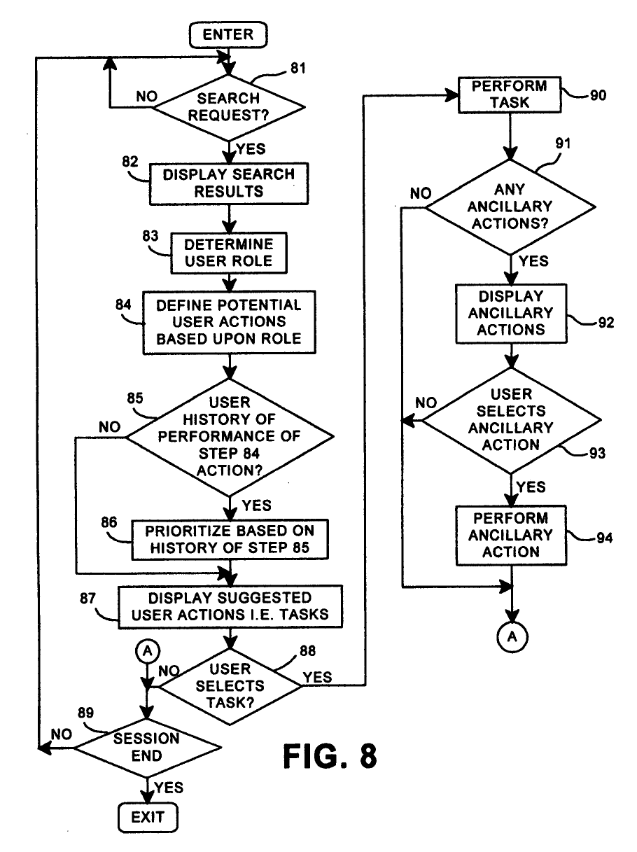

Now that the basic program set up has been described, there will be described with respect to FIG. 8 a flowchart of a simple operation system showing how the program could be run. During the running of the process, a determination is made as to whether a user has requested a search, step 81. If Yes, the search is performed and the results displayed, step 82. The user role is determined, step 83, and user actions based upon the user role are determined, step 84. At this point, step 85, a determination is made as to whether there is any stored history of the user performance of user actions (step 84) If Yes, then, step 36, the user actions to be presented are prioritized based upon this stored history. Then, or if the determination in step 85 is No, the prioritized user actions or tasks that may be performed by user with respect to the search activities or functions of the search results are displayed, step 87. A determination is then made as to whether the user has selected to perform one of the suggested activities or tasks, step 88. If No, then, this may be a convenient point at which a determination may conveniently be made as to whether the session is over, step 89. If Yes, the session is exited. If No, the session is not over, the process is branched back to step 81. If the determination in step 88 is Yes, then the selected task is performed, step 90, and a further determination is made as to whether the user has any ancillary actions that he may wish to perform. If Yes, such possible ancillary actions are displayed, step 92. A determination is then made, step 93, as to whether the user has selected to perform any of the possible action of step 92. If Yes, the selected actions are performed, step 94. At this point, or if the determination in steps 91 or 93 are No, the process is branched via “A” to step 89 where a determination may conveniently be made as to whether the session is over.

One of the implementations of the present invention may be in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In an information technology management system database for the coordination of information technology related activities for an enterprise, a method for presenting results responsive to a user requested search comprising:
responsive to a user search request, searching said management system database to generate user requested information on selected activities;
determining the role of the requesting user relative to said selected activities;
tracking the frequency of use of the requesting user's actions relative to said selected activities; and
presenting said search results to said requesting user, with suggested user actions customized based upon said role of said user, and prioritized based upon said frequency of use.

2. The method of claim 1 wherein said search results are displayed to said user.

3. The method of claim 1 wherein said management system database conforms to the Information Technology Infrastructure Library (ITIL) standard.

4. The method of claim 1 further including the steps of:
storing, in association with the user, information representative of additional ancillary actions specific to said user; and
suggesting at least one selectable additional action to said user.

5. The method of claim 2 further including the steps of:
tracking prior specific actions performed by said user ancillary to the performance by said user of at least one of said suggested actions; and
suggesting said ancillary actions to said user responsive to the presentation of said at least one suggested action.

6. The method of claim 2 further including the step of:
determining the operating mode of the requesting user relative to said selected activities; and
further customizing the suggested user actions based upon said operating mode of said requesting user.

7. The method of claim 3 wherein said management system database is a change and configuration management database.

8. An information technology management system database for the coordination of information technology related activities for an enterprise, a system for presenting results responsive to a user requested search comprising:
means, responsive to user's search request, for searching said management system database to generate user requested information on selected activities;
means for determining the role of the requesting user relative to said selected activities;
means for tracking the frequency of use of the requesting user's actions relative to said selected activities; and
means for presenting said search results to said requesting user, with suggested user actions customized based upon said role of said user, and prioritized based upon said frequency of use.

9. The system of claim 8 wherein said means for presenting said search results display such results to said user.

10. The system of claim 8 wherein said management system database conforms to the Information Technology Infrastructure Library (ITIL) standard.

11. The system of claim 8 further including:
means for storing, in association with the user, information representative of additional ancillary actions specific to said user; and
means for suggesting at least one selectable additional action to said user.

12. The system of claim 9 further including:
means for tracking prior specific actions performed by said user ancillary to the performance by said user of at least one of said suggested actions; and
means for suggesting said ancillary actions to said user responsive to the presentation of said at least one suggested action.

13. The system of claim 9 further including:
means for determining the operating mode of the requesting user relative to said selected activities; and
means for further customizing the suggested user actions based upon said operating mode of said requesting user.

14. The system of claim 10 wherein said management system database is a change and configuration management database.

15. A computer program having code recorded on a computer readable medium for presenting results responsive to user/s requested search in an information technology management system database for the coordination of information technology related activities for an enterprise comprising:
means, responsive to user's search request, for searching said management system database to generate user requested information on selected activities;
means for determining the role of the requesting user relative to said selected activities;
means for tracking the frequency of use of the requesting user's actions relative to said selected activities; and
means for presenting said search results to said requesting user, with suggested user actions customized based upon said role of said user, and prioritized based upon said frequency of use.

16. The computer program of claim 15 wherein said means for presenting said search results display such results to said user.

17. The computer program of claim 15 wherein said management system database conforms to the Information Technology Infrastructure Library (ITIL) standard.

18. The computer program of claim 15 further including:
means for storing, in association with the user, information representative of additional ancillary actions specific to said user; and
means for suggesting at least one selectable additional action to said user.

19. The computer program of claim 16 further including:
means for tracking prior specific actions performed by said user ancillary to the performance by said user of at least one of said suggested actions; and
means for suggesting said ancillary actions to said user responsive to the presentation of said at least one suggested action.

20. The computer program of claim 16 further including:
means for determining the operating mode of the requesting user relative to said selected activities; and
means for further customizing the suggested user actions based upon said operating mode of said requesting user.
